(19) United States
(12) Patent Application Publication
(10) Pub. No.: US 2020/0104812 A1
(43) Pub. Date: Apr. 2, 2020

(54) DEPTH PAYMENT SPLITTING METHOD AND SYSTEM FOR USE IN DYNAMIC NETWORK BALANCING

(71) Applicant: HANGZHOU PINGPONG INTELLIGENT TECHNICAL CO., LTD, Zhejiang (CN)

(72) Inventors: Yu CHEN, Zhejiang (CN); Ning WANG, Zhejiang (CN); Peng CHEN, Zhejiang (CN); Wei XIONG, Zhejiang (CN); Shuai LU, Zhejiang (CN)

(73) Assignee: HANGZHOU PINGPONG INTELLIGENT TECHNICAL CO., LTD, Zhejiang (CN)

(21) Appl. No.: 16/604,902

(22) PCT Filed: Apr. 10, 2018
(86) PCT No.: PCT/CN2018/082429

§ 371 Date: Oct. 11, 2019

(30) Foreign Application Priority Data
Apr. 11, 2017 (CN) 201710233987.5

(51) Int. Cl. G06Q 20/10; G06Q 40/02; G06Q 20/40; G06Q 30/06

(52) U.S. Cl. CPC G06Q 20/10; G06Q 30/0643; G06Q 20/40; G06Q 40/02

(57) ABSTRACT

An in-depth payment splitting method and an in-depth payment splitting system for dynamic network balance are provided. In the method, a node from which a fund inflows is determined as a primary node, dynamic fund flow relationships with the primary node in a time window are summarized, and a payment network at a preset payment depth is generated based on the summarized fund flow relationships. Under the condition of balance between fund inflows and fund outflows at nodes, spaced nodes in a fund flow having a multi-level link or a duplicate link in the payment network are directly connected and adjacent nodes in the fund flow are pruned to shorten payment paths. A new payment network is generated based on new fund flow relationships. Splitting payment is performed in accordance with fund flow paths in the new payment network.

The present application claims priority to Chinese Patent Application No. 201710233987.5, titled “DEPTH PAYMENT SPLITTING METHOD AND SYSTEM FOR USE IN DYNAMIC NETWORK BALANCING”, filed on Apr. 11, 2017 with Chinese Patent Office, which is incorporated herein by reference in its entirety.

### FIELD

The present disclosure relates to the technical field of financial payment, and in particular to an in-depth payment splitting method and an in-depth payment splitting system for dynamic network balance.

### BACKGROUND

At present, with the development of world economic integration and globalization, social production and trade dramatically changes in terms of organizational form, the depth and breadth of commercial trade activities are greatly expanded, and conventional regional production and sales modes are replaced by global procurement, production, logistics distribution and sales models. For example, for a merchant engaged in cross-border trade, customers of the merchant are spread all over the world, and goods sold by the merchant are from thousands of products provided by dozens or even hundreds of manufacturers, and the manufacturers purchase raw materials from hundreds of raw material suppliers to perform the production. For another example, for a company providing global travel services, clients of the company are spread all over the world, and suppliers of the company include attractions, hotels, airlines, railways, car rental companies, cruise companies, and restaurants around the world. For the above global service trade field, customers, merchants, manufacturers and suppliers in the supply chain constitute a global supply chain network that is highly complex and dynamically changing.

After goods or services are provided to a consumer, the fund paid by the consumer flows backwards in the above complex network and is distributed at various processes and nodes to complete a closed loop of global commercial trade. In this process, the monetary performance of property and materials is fund, and these funds are always in constant flow, and the inflow and the outflow of a fund are collectively referred to as a fund flow. The fund flow indicates the flow of funds in the entire supply chain, which is the flow of funds between members of the marketing channel as the physical goods and the ownership of the goods are transferred. The fund flow mainly refers to fund transferring processes, including fund payment, transfer, settlement, and exchange. The elements of the fund flow exist in the entire supply chain, which exist in any type of fund flow processes, such as raw material procurement, manufacturing, sales, consumption, and waste recycling, as well as in various fund flow activities, such as transportation, storage, packaging, loading and unloading, distribution processing, and logistics information.

The fund flow is blood of an enterprise, which decides the fate of the enterprise. The expenditure and income of the funds of an enterprise often occur at different time instants, which results in a cash flow gap in the operation of the enterprise. Therefore, the timely receipt of the funds receivable is of great significance to the operation of the enterprise. A chain fund flow payment manner is adopted in the conventional trade supply chain of “production-trade-wholesale-retail”. Reference is made to FIG. 1, which shows a conventional chain fund flow payment model. In the payment model, after a customer receives a service or product, the customer pays a fund in a certain way to an upstream distributor of the supply chain providing the service or product, the distributor pays to a manufacturer, and then the manufacturer pays to a supplier, thus the fund is paid step by step, forming a fund flow in the entire supply chain. In the chain fund flow model, each enterprise only has fund relationships with an upstream and a downstream of the enterprise. For each enterprise in the supply chain, the state of the fund flow is directly affected by the upstream (supplier) and the downstream (distributor). The operational efficiency and dynamic optimization of the fund flow in the entire supply chain are directly related to the operation of the enterprises in the supply chain. The conventional chain fund flow payment model is difficult to meet the payment requirements of the current highly complex and dynamically changing supply chains network of global service trade mode. The conventional chain fund flow payment model has the following two defects: (1) banks or third-party institutions charge a lot of fees at each payment process due to the flow of funds at multiple levels, resulting in high costs of fund flow of enterprises; and (2) the fund turnover rate is low in the conventional chain fund flow model, and the funds reaches the most upstream suppliers after passing through all the node enterprises in the entire supply chain, such that the payment time is long for upstream suppliers, causing great pressure on the operation of the enterprises due to the lack of timely withdrawal of funds.

### SUMMARY

A technical problem to be solved by the present disclosure is to provide an in-depth payment splitting method and an in-depth payment splitting system for dynamic network balance, to achieve effects of improving fund payment efficiency, reducing fund flow processes and reducing costs in the payment process.

In order to solve the above problem, an in-depth payment splitting method for dynamic network balance is provided in the present disclosure. The in-depth payment splitting method includes:
S1: determining a node from which a fund inflows as a primary node, summarizing dynamic fund flow relationships in which the primary node serves as an overall payment source in a time window, and generating a payment network at a preset payment depth based on the summarized fund flow relationships between the primary node and secondary nodes at all levels;
S2: directly connecting spaced nodes and pruning adjacent nodes a fund flow having a multi-level link or a duplicate link in the payment network under the condition of balance between fund inflows and fund outflows at nodes, to shorten payment paths between the primary node and secondary nodes at a subordinate level and obtain new fund flow relationships between the primary node and the secondary nodes at all levels;
S3: generating a new payment network based on the new fund flow relationships between the primary node and the secondary nodes at all levels; and
S4: performing splitting payment from the primary node to the secondary nodes at the subordinate level in accordance with fund flow paths in the new payment network.

According to an embodiment of the present disclosure, step Si includes:
S11: defining a primary node, where a node from which a fund inflows is determined as the primary node;
S12: determining connection objects having a payment relationship with the primary node in a time window as secondary nodes at a first level, and determining a fund flow amount from the primary node to each of the secondary nodes at the first level to determine a payment sub-graph of the primary node;
S13: determining connection objects having a payment relationship with secondary nodes at an i-th level in the time window as secondary nodes at an (i+1)-th level, and determining a fund flow amount from each of the secondary nodes at the i-th level to each of the secondary nodes at the (i+1)-th level connected with the secondary node at the i-th level, and if there is a payment relationship between the secondary nodes at the i-th level, determining a fund flow amount from one of the secondary nodes at the i-th level to another secondary node at the i-th level connected with the secondary node at the i-th level, to determine payment sub-graphs of all of the secondary nodes at the i-th level, where i is an integer ranging from one to (P-1), and P indicates the preset payment depth, where the payment sub-graphs are determined progressively beginning from the secondary nodes at the first level; and
S14: generating a payment network having a payment depth of P in the time window based on the payment sub-graphs.

According to an embodiment of the present disclosure, the fund flow amount is a sum of funds paid between two adjacent nodes in the time window.

According to an embodiment of the present disclosure, step S2 includes: newly generating, for one, some or all of secondary nodes at the first level in the payment network based on fund flow links between the primary node and the secondary nodes at the first level and fund flow links between each of the secondary nodes at the first level and one, some or all of adjacent secondary nodes connected to the secondary node at the first level, fund flow links between the primary node and the adjacent secondary nodes under the condition of balance between fund inflows and fund outflows, and pruning superfluous fund flow links.

According to an embodiment of the present disclosure, step S2 includes:
S21: selecting one of the secondary nodes at the first level in the payment network;
S22: selecting an adjacent secondary node connected to the secondary node at the first level, and determining, based on a fund flow link between the primary node and the secondary node at the first level and a fund flow link between the secondary node at the first level and the adjacent secondary node, a fund flow amount difference between the fund flow links, where the adjacent secondary node is a secondary node at the first level or a secondary node at a second level;
S23: generating a fund flow link between the primary node and the adjacent secondary node and pruning the fund flow link between the secondary node at the first level and the adjacent secondary node, in a case that the fund flow amount difference is greater than zero; generating a fund flow link between the primary node and the adjacent secondary node and pruning the fund flow link between the secondary node at the first level and the adjacent secondary node and the fund flow link between the primary node and the secondary node at the first level, in a case that the fund flow amount difference is equal to zero; and generating a fund flow link between the primary node and the adjacent secondary node and pruning the fund flow link between the primary node and the secondary node at the first level, in a case that the fund flow amount difference is less than zero, where the balance between fund inflows and fund outflows at the primary node, the secondary node at the first level and the adjacent secondary node is not disrupted by the adjusted fund flow links;
S24: selecting another adjacent secondary node connected to the secondary node at the first level, and repeating steps S22 to S23 until all or specified adjacent secondary nodes connected to the secondary node at the first level are adjusted; and
S25: selecting another of the secondary nodes at the first level in the payment network, and repeating steps S22 to S24 until all or specified secondary nodes at the first level are adjusted.

According to an embodiment of the present disclosure, step S2 further includes: after the secondary nodes at the first level are adjusted,
newly generating, for one, some or all of secondary nodes at a second level in the payment network based on fund flow links between the secondary nodes at the first level and the secondary nodes at the second level and fund flow links between each of the secondary nodes at the second level and one, some or all of adjacent secondary nodes connected to the secondary node at the second level, new fund flow links between the secondary nodes at the first level and the corresponding adjacent secondary nodes under the condition of balance between fund inflows and fund outflows, and pruning superfluous fund flow links, until fund flow links between the primary node and secondary nodes at a last level are adjusted.

According to an embodiment of the present disclosure, step S4 includes:
S41: dividing nodes in the new payment network into net inflow nodes and net outflow nodes according to fund inflows and fund outflows of the nodes, where an inflow fund amount of each of the net inflow nodes is larger than an outflow fund amount of the net inflow node, and an inflow fund amount of each of the net outflow nodes is smaller than an outflow fund amount of the net outflow node; and
S42: performing, for each net inflow node, splitting payment in accordance with corresponding fund flow links in the new payment network; and sending a fund complementing request for each net outflow node, and if a net outflow fund of the net outflow node is complemented, performing splitting payment in accordance with corresponding fund flow links in the new payment network, or if the net outflow fund is not complemented, recording a lacked fund as an unpaid account to serve as an initial fund flow link for a next payment network and performing splitting payment on remaining funds in accordance with the fund flow links in the new payment network.

According to an embodiment of the present disclosure, the in-depth payment splitting method further includes S5: recording a virtual payment path and an actual payment path of a fund, and generating a settlement voucher for the virtual payment path according to an actual payment situation at each node and distributing the settlement voucher as a fund payment voucher of the node to the node, where the virtual payment path is a payment path in an initial payment network, the actual payment path is a payment path in the new payment network, and the settlement voucher includes at least a paid account of the node to nodes connected to the node.

According to an embodiment of the present disclosure, step S5 further includes: recording each unpaid account as an initial fund flow link for a next payment network.

An in-depth payment splitting system for dynamic network balance is further provided in the present disclosure. The in-depth payment splitting system includes an initial payment network generating module, a path shortening and pruning module, a new payment network generating module, and a splitting payment module, where
the initial payment network generating module is configured to: determine a node from which a fund inflows as a primary node, summarize dynamic fund flow relationships in which the primary node serves as an overall payment source in a time window, and generate a payment network at a preset payment depth based on the summarized fund flow relationships between the primary node and secondary nodes at all levels;
the path shortening and pruning module is configured to directly connect spaced nodes and prune adjacent nodes in a fund flow having a multi-level link or a duplicate link in the payment network under the condition of balance between fund inflows and fund outflows at nodes, to shorten payment paths between the primary node and secondary nodes at a subordinate level and obtain new fund flow relationships between the primary node and the secondary nodes at all levels;
the new payment network generating module is configured to generate a new payment network based on the new fund flow relationships between the primary node and the secondary nodes at all levels; and
the splitting payment module is configured to perform splitting payment from the primary node to the secondary nodes at the subordinate level in accordance with fund flow paths in the new payment network.

According to an embodiment of the present disclosure, the in-depth payment splitting system further includes a settlement voucher distributing module. The settlement voucher distributing module is configured to: record a virtual payment path and an actual payment path of a fund, and generate a settlement voucher for the virtual payment path according to an actual payment situation at each node and distribute the settlement voucher as a fund payment voucher of the node to the node, where the virtual payment path is a payment path in an initial payment network, the actual payment path is a payment path in the new payment network, and the settlement voucher includes at least a paid account of the node to nodes connected to the node.

With the above technical solutions, the present disclosure has the following beneficial effects compared with the conventional technology.

Compared with the conventional chain fun flow payment model, the payment relationship in the present disclosure is a typical network structure, that is, in a whole process of a supply chain from the procurement of raw materials to the production, circulation, and consumption, the relationship between enterprises is not only a simple chain fund flow of upstream and downstream, and the enterprises form a dynamically changing network relationship through the connection of time and space between the funds paid by each other. A node at which a fund inflows at a current time instant is determined as a primary node, and a node from which an account required to be paid by the primary node inflows in a specified time window is determined as a secondary node at a first level, and a node from which an account required to be paid by the secondary node at the first level inflows in the specified time window is determined as a secondary node at a second level, and so on, thus a payment network having a certain depth is formed. Time-based internal balance and aggregation are performed on fund flows in the payment network, and path shortening and pruning is performed on the fund flow required to be paid repeatedly or in multiple links, to obtain an actual fund clearing and settlement network. Based on the actual fund clearing and settlement network, splitting payment and clearing is performed. The account required to be paid by the primary node are allocated or diverted in the actual fund clearing and settlement network, and are directly split and settled to a fund inflow party in the actual fund clearing and settlement network, realizing a rapid collection and flexible allocation of funds, improving the turnover efficiency and utilization of fund flows in the supply chain, and reducing the turnover cost of funds.

### BRIEF DESCRIPTION OF THE DRAWINGS

FIG. 1 is a schematic diagram showing a conventional chain fund flow payment model;

FIG. 2 is a flow chart of an in-depth payment splitting method for dynamic network balance according to an embodiment of the present disclosure;

FIG. 3 is a flow chart of an in-depth payment splitting method for dynamic network balance according to another embodiment of the present disclosure;

FIG. 4a is schematic structural diagram showing a payment sub-graph of a primary node according to an embodiment of the present disclosure;

FIG. 4b is schematic structural diagram showing a payment network having a depth of 2 according to an embodiment of the present disclosure;

FIG. 5a is a schematic structural diagram showing fund flow link adjustment according to an embodiment of the present disclosure;

FIG. 5b is a schematic structural diagram showing fund flow link adjustment according to an embodiment of the present disclosure;

FIG. 5c is a schematic structural diagram showing fund flow link adjustment according to an embodiment of the present disclosure;

FIG. 6a is a schematic structural diagram showing an initial payment network according to an embodiment of the present disclosure; and

FIG. 6b is a schematic structural diagram showing a new payment network according to an embodiment of the present disclosure.

### DETAILED DESCRIPTION OF THE EMBODIMENTS

In order to make the above objects, features and advantages of the present disclosure more apparent and easier to be understood, embodiments of the present disclosure are described in detail below with reference to the drawings.

Specific details are described in the following description so that the present disclosure can be understood completely. However, the present disclosure may also be embodied in other ways, a similar extension can be made by those skilled in the art without departing from intension of the present disclosure. Therefore, the present disclosure is not limited to the specific embodiments described below.

Referring to FIG. 2, an in-depth payment splitting method for dynamic network balance is provided according to an embodiment of the present disclosure. The method includes the following steps S1 to S4.

In step S1, a node from which a fund inflows is determined as a primary node, dynamic fund flow relationships in which the primary node serves as an overall payment source in a time window are summarized, and a payment network at a preset payment depth is generated based on the summarized fund flow relationships between the primary node and secondary nodes at all levels.

In step S2, under the condition of balance between fund inflows and fund outflows at nodes, spaced nodes in a fund flow having a multi-level link or a duplicate link in the payment network are directly connected and adjacent nodes in the fund flow are pruned, to shorten payment paths between the primary node and secondary nodes at a subordinate level and obtain new fund flow relationships between the primary node and the secondary nodes at all levels.

In step S3, a new payment network is generated based on the new fund flow relationships between the primary node and the secondary nodes at all levels.

In step S4, splitting payment from the primary node to the secondary nodes at the subordinate level is performed in accordance with fund flow paths in the new payment network.

The in-depth payment splitting method for dynamic network balance according to the embodiment of the present disclosure may be performed only once, so that the path shortening and pruning optimization is performed once. The method may also be repeatedly performed several times, so that the path shortening and pruning optimization is performed several times. In this case, the node at which a fund inflows, that is determined as the primary node in step S1, may be an upstream node or an intermediate node in an initial supply chain, or may be an upstream node or an intermediate node in a new payment network obtained by (repeatedly) performing the in-depth payment splitting method for dynamic network balance according to the embodiment of the present disclosure. Therefore, the primary node is not limited in terms of a specific position, as long as a fund can inflow from the node and can outflow to a subsequent node.

In step S1, a node from which a fund inflows at a current time instant is determined as the primary node, a node from which an account required to be paid by the primary node inflows in a preset time window is determined as a secondary node at a first level, and a node from which an account required to be paid by the secondary node at the first level inflows in the time window is determined as a secondary node at a second level, and so on, thus a payment network having a certain depth is formed. The payment network is not limited in terms of a topology, which may be in a shape of a star, a tree, a ring, a mesh, or the like.

In step S2, under the condition of balance between fund inflows and fund outflows at nodes, spaced nodes in a fund flow having a multi-level link or a duplicate link in the payment network are directly connected and adjacent nodes in the fund flow are pruned, to shorten payment paths between the primary node and secondary nodes at a subordinate level. For example, before optimization is performed, a node A pays an account only to a node B, and the node B pays an account to a node C. The node A pays an account directly to the node C by the optimization, that is, the direct connection between the node A and the node C is performed, and the pruning between the node B and the node C is performed. The direct connection and the pruning are performed under the condition of the balance between fund inflows and fund outflows at the nodes. A fund flow amount of each of the node A, the node B, and the node C before the optimization is the same as that of the node after the optimization.

In step S3, a new payment network is generated based on new fund flow relationships between the primary node and the secondary nodes at all levels obtained after the direct connection and pruning optimization are performed in step S2. If there is a payment relationship between nodes, there is a link between the nodes. If there is no payment relationship between nodes, there is no link between the nodes. The link has a directivity representing a payment direction, and one or more continuous fund flow links represent a payment path. In the new payment network, there is a link between the primary node and a secondary node after a secondary node at the first level, so that cross-level direct payment can be performed.

In step S4, splitting payment from the primary node to the secondary nodes at the subordinate level is performed in accordance with fund flow paths in the new payment network determined in step S3.

Compared with the conventional chain fun flow payment model, the payment relationship in the present disclosure is a typical network structure, that is, in a whole process of a supply chain from the procurement of raw materials to the production, circulation, and consumption, the relationship between enterprises is not only a simple chain fund flow of upstream and downstream, and the enterprises form a dynamically changing network relationship through the connection of time and space between the funds paid by each other. A node at which a fund inflows at a current time instant is determined as a primary node, and a node from which an account required to be paid by the primary node inflows in a specified time window is determined as a secondary node at a first level, and a node from which an account required to be paid by the secondary node at the first level inflows in the specified time window is determined as a secondary node at a second level, and so on, thus a payment network having a certain depth is formed. Time-based internal balance and aggregation are performed on fund flows in the payment network, and path shortening and pruning is performed on the fund flow required to be paid repeatedly or in multiple links, to obtain an actual fund clearing and settlement network. Based on the actual fund clearing and settlement network, splitting payment and clearing is performed. The account required to be paid by the primary node are allocated or diverted in the actual fund clearing and settlement network, and are directly split and settled to a fund inflow party in the actual fund clearing and settlement network, realizing a rapid collection and flexible allocation of funds, improving the turnover efficiency and utilization of fund flows in the supply chain, and reducing the turnover cost of funds.

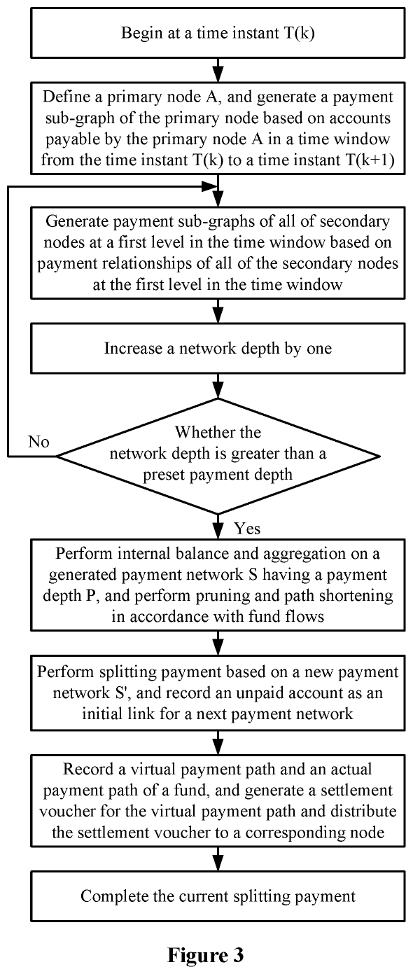

Referring to FIG. 3, in an optimized embodiment, step S1 includes the following steps S11 to S14.

In step S11, a primary node is defined, where a node from which a fund inflows is determined as the primary node.

In step S12, connection objects having a payment relationship with the primary node in a time window are determined as secondary nodes at a first level, and a fund flow amount from the primary node to each of the secondary nodes at the first level is determined to determine a payment sub-graph of the primary node.

In step S13, connection objects having a payment relationship with secondary nodes at an i-th level in the time window are determined as secondary nodes at an (i+1)-th level, and a fund flow amount from each of the secondary nodes at the i-th level to each of the secondary nodes at the (i+1)-th level connected with the secondary node at the i-th level is determined. If there is a payment relationship between the secondary nodes at the i-th level, a fund flow amount from one of the secondary nodes at the i-th level to another secondary node at the i-th level connected with the secondary node at the i-th level is determined, to determine payment sub-graphs of all of the secondary nodes at the i-th level, where i is an integer ranging from one to (P-1), and P indicates the preset payment depth. The payment sub-graphs are determined progressively beginning from the secondary nodes at the first level.

In step S14, a payment network having a payment depth of P in the time window is determined based on the payment sub-graphs.

Preferably, the fund flow amount is a sum of funds paid between two adjacent nodes in the time window. That is, fund flows between a same payer node and a same payee node in the time window are merged, simplifying the network structure and reducing the number of times performing the pruning.

More specifically, it is assumed that the preset payment depth is indicated by P. Step S1 is described in detail below with reference to FIG. 3, which includes the following steps (1) to (6).

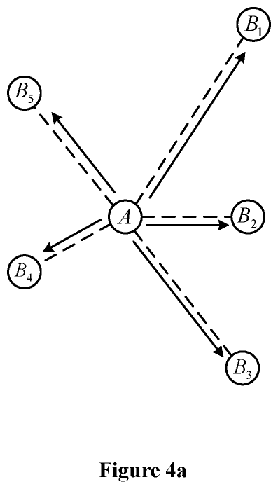

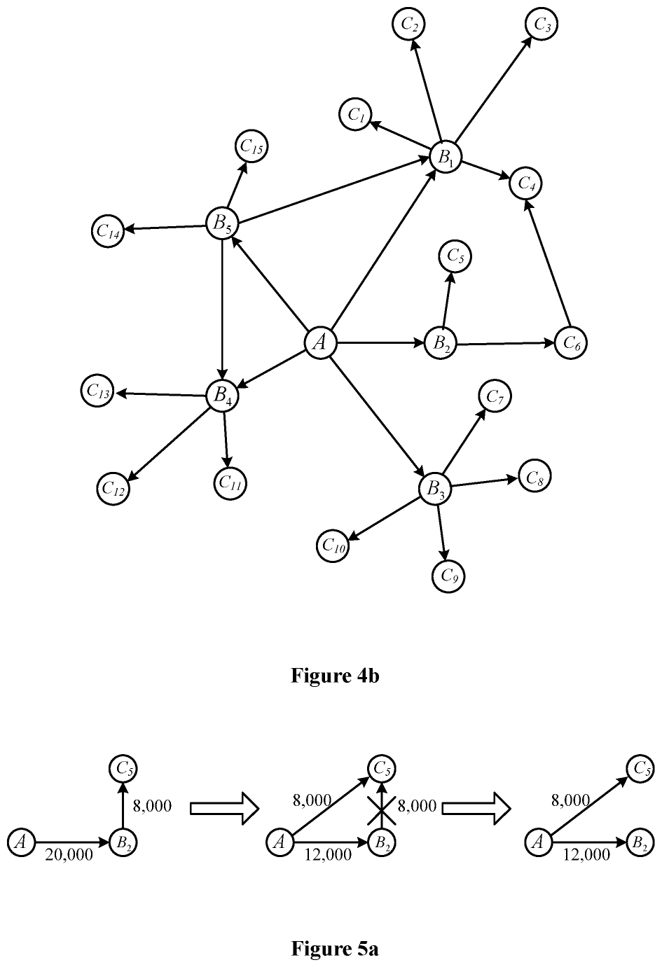

In (1), a primary node A is determined, and a payment sub-graph of the primary node in a time period is obtained. It is assumed that, A_{M} secondary nodes at the first level are required to be paid in a time window after a time instant T(k) (a time period from the time instant T(k) to a time instant T (k+1)), and the secondary nodes at the first level are indicated as Bᵢ, i∈[1, . . . A_{M}]. In the time period from T(k) to T(k+1) , a fund flow amount from the primary node A to the secondary node Bᵢ at the first level is indicated as Q_{A→B}_{ᵢ}, which represents a sum of funds required to be paid from the primary node A to the secondary node Bᵢ at the first level in the time period from T(k) to T(k+1). Referring to FIG. 4a, in a payment sub-graph of the primary node A, secondary nodes from B1 to B5 at the first level and respective links are shown.

In (2), payment sub-graphs of all of the secondary nodes at the first level in the time period from T(k) to T(k+1) are generated based on payment relationships of all of the secondary nodes Bᵢ at the first level in the time period from T(k) to T(k+1). That is, It is assumed that, Bᵢ_{_{M}} secondary nodes at a second level are required to be paid by the secondary node Bᵢ at the first level, in the time window after the time instant T(k) (the time period from the time instant T(k) to a time instant T(k+1)), and the secondary nodes at the second level are indicated as Cⱼ, j∈[0, . . . Bⁱ_{M}]. In the time period from T(k) _{to T(k+}1), a fund flow amount from the secondary node Bᵢ at the first level to the secondary node Cⱼ at the second level is indicated as Q_{B}_{ᵢ}_{→C}_{ⱼ}, which represents a sum of funds required to be paid from the secondary node Bᵢ at the first level to the secondary node Cⱼ at the second level in the time period from T(k) to T(k+1). For ease of understanding, a star-shaped network structure is described in the present embodiment. A payment relationship may exist between secondary nodes at a same level in practice, which has more applicability. Referring to FIG. 4b, based on the payment sub-graph of the primary node, payment sub-graphs of the secondary nodes from B1 to B5 at the first level are generated, in which secondary nodes from C1 to C15 at a second level and respective links are shown.

In (3), step (2) is repeatedly performed at the preset payment depth P to obtain a dynamic payment network S having the preset payment depth P in the time window from T(k) to T(k+1). The preset payment depth may be determined based on the number of processes in which payment is actually required, and the number of times repeating step (2) may be determined as required. The present disclosure is not limited to the case that a direct payment relationship must exist between the primary node and a final secondary node, which is preferred. The technical effect can be achieved as long as a payment path between the primary node and the final secondary node can be shortened.

In an embodiment, step S2 includes: newly generating, for one, some or all of secondary nodes at the first level in the payment network based on fund flow links between the primary node and the secondary nodes at the first level and fund flow links between each of the secondary nodes at the first level and one, some or all of adjacent secondary nodes connected to the secondary node at the first level, fund flow links between the primary node and the adjacent secondary nodes under the condition of balance between fund inflows and fund outflows, and pruning superfluous fund flow links.

In an optimized embodiment, referring to FIG. 3, internal balance and aggregation is performed on the generated payment network having the payment depth P, and path shortening and pruning is performed in accordance with fund flows. Step S2 includes the following steps S21 to S25.

In step S21, one of the secondary nodes at the first level in the payment network is selected.

In step S22, an adjacent secondary node connected to the secondary node at the first level is selected. Based on a fund flow link between the primary node and the secondary node at the first level and a fund flow link between the secondary node at the first level and the adjacent secondary node, a fund flow amount difference between the fund flow links is determined. The adjacent secondary node is a secondary node at the first level or a secondary node at a second level.

In step S23, in a case that the fund flow amount difference is greater than zero, a fund flow link between the primary node and the adjacent secondary node is generated, and the fund flow link between the secondary node at the first level and the adjacent secondary node is pruned. In a case that the fund flow amount difference is equal to zero, a fund flow link between the primary node and the adjacent secondary node is generated, and the fund flow link between the secondary node at the first level and the adjacent secondary node and the fund flow link between the primary node and the secondary node at the first level are pruned. In a case that the fund flow amount difference is less than zero, a fund flow link between the primary node and the adjacent secondary node is generated, and the fund flow link between the primary node and the secondary node at the first level is pruned. The balance between fund inflows and fund outflows at the primary node, the secondary node at the first level and the adjacent secondary node is not disrupted by the adjusted fund flow links.

In step S24, another adjacent secondary node connected to the secondary node at the first level is selected, and steps S22 to S23 are repeated until all or specified adjacent secondary nodes connected to the secondary node at the first level are adjusted.

In step S25, another of the secondary nodes at the first level in the payment network is selected, and steps S22 to S24 are repeated until all or specified secondary nodes at the first level are adjusted.

By performing the path shortening and pruning based on the fund flow amount difference, so that all unnecessary branches and knots can be accurately pruned, simplifying the network structure and optimizing the payment path, and thus simplifying the unnecessary repeated query processing for superfluous branches in the repetition process, and improving efficiency.

In addition, step S2 further includes: after the secondary nodes at the first level are adjusted, newly generating, for one, some or all of secondary nodes at a second level in the payment network based on fund flow links between the secondary nodes at the first level and the secondary nodes at the second level and fund flow links between each of the secondary nodes at the second level and one, some or all of adjacent secondary nodes connected to the secondary node at the second level, new fund flow links between the secondary nodes at the first level and the corresponding adjacent secondary nodes under the condition of balance between fund inflows and fund outflows, and pruning superfluous fund flow links, until fund flow links between the primary node and secondary nodes at a last level are adjusted.

More specifically, the following operations are performed immediately after step (3) in the above embodiment.

In (4), internal balance and aggregation are performed on the dynamic payment network having the preset payment depth P generated in step (3), to shorten the number of nodes flowing through by a fund flow as much as possible. By the network balance, path shortening and splitting is performed on the fund flow in the payment network, and the fund is directly injected into the final payment node. For example, in the dynamic payment network, if there is an account Q_{A→B}_{₂} to be paid by the primary node A to a secondary node B₂ at the first level, and an account Q_{B}_{₂}_{→C}_{₅} to be paid by the secondary node B₂ at the first level to a secondary node C₅ at the second level, the path shortening and splitting is performed as follows:
in the case of Q_{A→B}_{₂}>Q_{B}_{₂}_{→C}_{₅}, sub-step (4-1) is performed;
in the case of Q_{A→B}_{₂}=Q_{B}_{₂}_{→C}_{₅}, sub-step (4-2) is performed; and
in the case of Q_{A→B}_{₂}<Q_{B}_{₂}_{→C}_{₅}, sub-step (4-3) is performed.

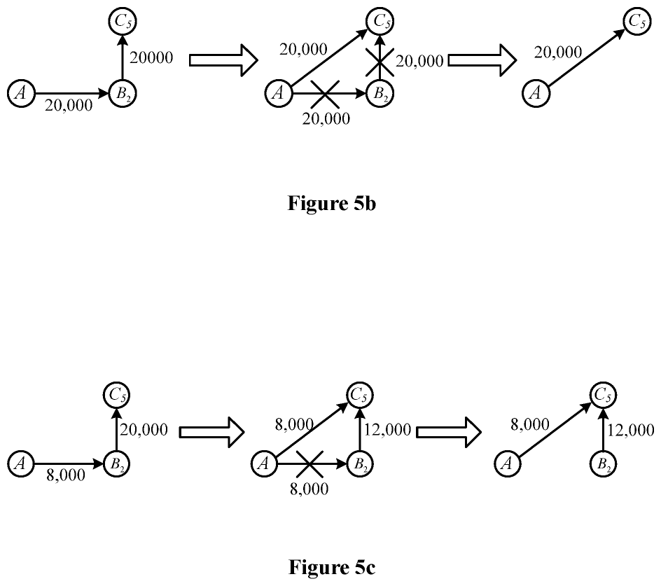

In sub-step (4-1), as shown in FIG. 5a, 20000>8000, and a new fund flow link is generated, which is denoted as A→C₅. In this case, it is assumed that Q_{A→C}_{₅}=Q_{B}_{₂}_{→C}_{₅} (8000), a fund flow link A→B₂ is retained. Then, it is further assumed that Q′_{A→B}_{₂}=Q_{A→B}_{₂}−Q_{B}_{₂}_{→C}_{₅} (12000), a fund flow link B₂→C₅ is pruned.

In sub-step (4-2), as shown in FIG. 5b, 20000=20000, and a new fund flow link is generated, which is denoted as A→C₅. In this case, it is assumed that Q_{A→C}_{₅}=Q_{A→B}_{₂} (20000), fund flow links A→B₂ and B₂→C₅ are pruned.

In sub-step (4-3), as shown in FIG. 5c, 8000<20000, and a new fund flow link is generated, which is denoted as A→C₅ . In this case, it is assumed that Q_{A→C}_{₅}=Q_{A→B}_{₂} (8000), a fund flow link A→B₂ is pruned. Then, it is further assumed that Q′_{B}_{₂}_{→C}_{₅}=Q_{B}_{₂}_{→C}_{₅}−Q_{A→B}_{₂} (12000), and a fund flow link B₂→C₅ is retained.

Next, step S3 of generating a new payment network based on the new fund flow relationships between the primary node and secondary nodes at all levels is performed.

Specifically, the following operations are performed immediately after step (4) in the above embodiment. In (5), the path shortening and pruning in step (4) is cyclically performed on all nodes, to generate a new payment network S′ after fund flow aggregation over time and space.

In an embodiment, step S4 includes the following steps S41 to S42.

In step S41, nodes in the new payment network are divided into net inflow nodes and net outflow nodes according to fund inflows and fund outflows of the nodes. An inflow fund amount of each of the net inflow nodes is larger than an outflow fund amount of the net inflow node, and an inflow fund amount of each of the net outflow nodes is smaller than an outflow fund amount of the net outflow node.

In step S42, for each net inflow node, splitting payment is performed in accordance with corresponding fund flow links in the new payment network. For each net outflow node, a fund complementing request is sent. If a net outflow fund of the net outflow node is complemented, splitting payment is performed in accordance with corresponding fund flow links in the new payment network. If the net outflow fund is not complemented, a lacked fund is recorded as an unpaid account to serve as an initial fund flow link for a next payment network and splitting payment is performed on remaining funds in accordance with the fund flow links in the new payment network.

Specifically, the following operations are performed immediately after step (5) in the above embodiment. In (6), nodes in the new payment network S′ are divided into net inflow nodes and net outflow nodes according to fund inflows and fund outflows of the nodes, which is performed as follows:
if an inflow fund amount of a node in S′ is larger than an outflow fund amount of the node, the node is determined as a net inflow node; and
if an inflow fund amount a node in S′ is smaller than an outflow fund amount of the node, the node is determined as a net outflow node.

For a net inflow node, there is no problem of insufficient payment in the existing fund flow. For a net outflow node, a system sends a fund complementing request to inquire a client whether the client would like to complement the fund to participate in the current in-depth aggregation payment. If the client would like to complement the fund, the in-depth aggregation payment splitting is performed in the new payment network S′ after the client complements the net outflow fund. If the client would not like to complement the fund, the fund lacked by the client is recorded as an unpaid account to serve as an initial fund flow link for a next payment network, and splitting payment is performed on remaining funds in the new payment network S′.

In an embodiment, the in-depth payment splitting method for dynamic network balance further includes step S5 (which is performed immediately after step (6) in the above embodiment: recording a virtual payment path and an actual payment path of a fund, and generating a settlement voucher for the virtual payment path according to an actual payment situation at each node and distributing the settlement voucher as a fund payment voucher of the node to the node, where the virtual payment path is a payment path in an initial payment network, the actual payment path is a payment path in the new payment network, and the settlement voucher includes at least a paid account of the node to nodes connected to the node.

In addition, in step S5, each unpaid account is recorded as an initial fund flow link for a next payment network.

For purposes of clarity, the following description is given by an example. A node A is required to pay 5000 Yuan to a node B, and the node B is required to pay 3000 Yuan to a node C. With the payment splitting method according to the embodiment of the present disclosure, the node A is required to pays 3000 Yuan to the node C and pay 2000 Yuan to the node B actually. If the payment is completed, an issued voucher is that, the node A completes payment of 5000 Yuan to the node B and the node B completes payment of 3000 Yuan to the node C. If the node A pays only 2000 Yuan to the node C and pays 2000 Yuan to the node B, the issued voucher is that the node A completes payment of 4000 Yuan to the node B and the node B completes payment of 2000 Yuan to the node C. Unpaid accounts are recorded that the node A is still required to pay 1000 Yuan to the node B, and the node B is still required to pay 1000 Yuan to the node C, and the two to-be-paid accounts are used as an initial fund flow link for a next a payment network. The above example is applicable to the new payment network in the embodiment of the present disclosure.

In the conventional chain payment model, funds flow through each node step by step and reach the final upstream supplier or producer after flowing through all intermediate nodes, resulting in low turnover efficiency. Further, a wire transfer fee or a transfer fee is charged for each process, having defects of slow fund settlement and high cost. In the embodiments of the present disclosure, aggregation, balance and optimization are effectively performed on fund flows in a dynamic payment network in a time period, reducing the number of fund turnovers and the inefficient fund flow between nodes, improving the fund turnover efficiency, accelerating the fund settlement process, and reducing the cost generated during the fund turnover between nodes.

The present disclosure is further illustrated below in conjunction with a specific embodiment.

Firstly, a preset payment depth P of a dynamic network is set as 3, and a node A is taken as a primary node after Apr. 7, 2017. To-be-paid accounts are shown in the following Table 1.

TABLE 1
Initial to-be-paid accounts

| No. | Payer | Payee | Payment time | Amount |
|---|---|---|---|---|
| 1 | A | B₁ | 2017 Apr. 8 | 150,000 |
| 2 | A | B₁ | 2017 Apr. 9 | 220,000 |
| 3 | A | B₂ | 2017 Apr. 8 | 135,000 |
| 4 | A | B₂ | 2017 Apr. 10 | 147,000 |
| 5 | A | B₂ | 2017 Apr. 20 | 59,000 |
| 6 | A | B₃ | 2017 Apr. 10 | 130,000 |
| 7 | A | B₃ | 2017 Apr. 15 | 212,000 |
| 8 | B₁ | C₁ | 2017 Apr. 9 | 49,500 |
| 9 | B₁ | C₁ | 2017 Apr. 11 | 37,400 |
| 10 | B₁ | C₂ | 2017 Apr. 10 | 26,300 |
| 11 | B₁ | C₃ | 2017 Apr. 9 | 74,000 |
| 12 | B₁ | C₄ | 2017 Apr. 8 | 25,000 |
| 13 | B₂ | C₅ | 2017 Apr. 9 | 38,500 |
| 14 | B₂ | C₅ | 2017 Apr. 16 | 87,300 |
| 15 | B₂ | C₆ | 2017 Apr. 9 | 35,600 |
| 16 | B₃ | C₇ | 2017 Apr. 10 | 50,400 |
| 17 | B₃ | C₈ | 2017 Apr. 11 | 75,800 |
| 18 | C₁ | D₁ | 2017 Apr. 11 | 26,400 |
| 19 | C₁ | D₂ | 2017 Apr. 9 | 39,800 |
| 20 | C₁ | D₃ | 2017 Apr. 8 | 11,400 |
| 21 | C₁ | D₃ | 2017 Apr. 10 | 33,600 |
| 22 | C₂ | D₄ | 2017 Apr. 11 | 25,200 |
| 23 | C₂ | D₅ | 2017 Apr. 9 | 34,900 |
| 24 | C₃ | D₆ | 2017 Apr. 9 | 8,900 |
| 25 | C₃ | D₆ | 2017 Apr. 11 | 21,300 |
| 26 | C₃ | D₇ | 2017 Apr. 10 | 12,400 |
| 27 | C₃ | D₈ | 2017 Apr. 9 | 31,400 |
| 28 | C₄ | D₉ | 2017 Apr. 8 | 33,200 |
| 29 | C₄ | D₁₀ | 2017 Apr. 9 | 16,700 |
| 30 | C₅ | D₁₁ | 2017 Apr. 16 | 34,800 |
| 31 | C₅ | D₁₁ | 2017 Apr. 9 | 21,400 |
| 32 | C₅ | D₁₂ | 2017 Apr. 10 | 17,100 |
| 33 | C₆ | D₁₃ | 2017 Apr. 11 | 19,500 |
| 34 | C₆ | D₁₄ | 2017 Apr. 11 | 39,800 |
| 35 | C₆ | D₁₅ | 2017 Apr. 9 | 12,600 |
| 36 | C₇ | D₁₆ | 2017 Apr. 10 | 23,400 |
| 37 | C₇ | D₁₆ | 2017 Apr. 11 | 9,700 |
| 38 | C₇ | D₁₇ | 2017 Apr. 9 | 4,600 |
| 39 | C₇ | D₁₇ | 2017 Apr. 11 | 12,700 |
| 40 | C₈ | D₁₈ | 2017 Apr. 8 | 13,600 |
| 41 | C₈ | D₁₈ | 2017 Apr. 10 | 13,100 |
| 42 | C₈ | D₁₈ | 2017 Apr. 11 | 7,800 |
| 43 | C₈ | D₁₉ | 2017 Apr. 9 | 3,400 |
| 44 | C₈ | D₁₉ | 2017 Apr. 10 | 6,700 |
| 45 | C₈ | D₂₀ | 2017 Apr. 8 | 13,600 |
| 46 | C₈ | D₂₀ | 2017 Apr. 9 | 23,900 |

Next, a time window of 4 days is set for the to-be-paid accounts in Table 1, that is, to-be-paid accounts from Apr. 8, 2017 to Apr. 11, 2017 are screened. The screened to-be-paid accounts are shown in the following Table 2.

TABLE 2
Screened to-be-paid accounts

| No. | Payer | Payee | Payment time | Amount |
|---|---|---|---|---|
| 1 | A | B₁ | 2017 Apr. 8 | 150,000 |
| 2 | A | B₁ | 2017 Apr. 9 | 220,000 |
| 3 | A | B₂ | 2017 Apr. 8 | 135,000 |
| 4 | A | B₂ | 2017 Apr. 10 | 147,000 |
| 5 | A | B₃ | 2017 Apr. 10 | 130,000 |
| 6 | B₁ | C₁ | 2017 Apr. 9 | 49,500 |
| 7 | B₁ | C₁ | 2017 Apr. 11 | 37,400 |
| 8 | B₁ | C₂ | 2017 Apr. 10 | 26,300 |
| 9 | B₁ | C₃ | 2017 Apr. 9 | 74,000 |
| 10 | B₁ | C₄ | 2017 Apr. 8 | 25,000 |
| 11 | B₂ | C₅ | 2017 Apr. 9 | 38,500 |
| 12 | B₂ | C₆ | 2017 Apr. 9 | 35,600 |
| 13 | B₃ | C₇ | 2017 Apr. 10 | 50,400 |
| 14 | B₃ | C₈ | 2017 Apr. 11 | 75,800 |
| 15 | C₁ | D₁ | 2017 Apr. 11 | 26,400 |
| 16 | C₁ | D₂ | 2017 Apr. 9 | 39,800 |
| 17 | C₁ | D₃ | 2017 Apr. 8 | 11,400 |
| 18 | C₁ | D₃ | 2017 Apr. 10 | 33,600 |
| 19 | C₂ | D₄ | 2017 Apr. 11 | 25,200 |
| 20 | C₂ | D₅ | 2017 Apr. 9 | 34,900 |
| 21 | C₃ | D₆ | 2017 Apr. 9 | 8,900 |
| 22 | C₃ | D₆ | 2017 Apr. 11 | 21,300 |
| 23 | C₃ | D₇ | 2017 Apr. 10 | 12,400 |
| 24 | C₃ | D₆ | 2017 Apr. 9 | 8,900 |
| 25 | C₃ | D₆ | 2017 Apr. 11 | 21,300 |
| 26 | C₃ | D₇ | 2017 Apr. 10 | 12,400 |
| 27 | C₃ | D₈ | 2017 Apr. 9 | 31,400 |
| 28 | C₄ | D₉ | 2017 Apr. 8 | 33,200 |
| 29 | C₄ | D₁₀ | 2017 Apr. 9 | 16,700 |
| 30 | C₅ | D₁₁ | 2017 Apr. 16 | 34,800 |
| 31 | C₅ | D₁₁ | 2017 Apr. 9 | 21,400 |
| 32 | C₅ | D₁₂ | 2017 Apr. 10 | 17,100 |
| 33 | C₆ | D₁₃ | 2017 Apr. 11 | 19,500 |
| 34 | C₆ | D₁₄ | 2017 Apr. 11 | 39,800 |
| 35 | C₆ | D₁₅ | 2017 Apr. 9 | 12,600 |
| 36 | C₇ | D₁₆ | 2017 Apr. 10 | 23,400 |
| 37 | C₇ | D₁₆ | 2017 Apr. 11 | 9,700 |
| 38 | C₇ | D₁₇ | 2017 Apr. 9 | 4,600 |
| 39 | C₇ | D₁₇ | 2017 Apr. 11 | 12,700 |
| 40 | C₈ | D₁₈ | 2017 Apr. 8 | 13,600 |
| 41 | C₈ | D₁₈ | 2017 Apr. 10 | 13,100 |
| 42 | C₈ | D₁₈ | 2017 Apr. 11 | 7,800 |
| 43 | C₈ | D₁₉ | 2017 Apr. 9 | 3,400 |
| 44 | C₈ | D₁₉ | 2017 Apr. 10 | 6,700 |
| 45 | C₈ | D₂₀ | 2017 Apr. 8 | 13,600 |
| 46 | C₈ | D₂₀ | 2017 Apr. 9 | 23,900 |

Next, to-be-paid accounts from a same payer node to a same payee node during the time period are merged. The merged to-be-paid accounts are shown in the following Table 3.

TABLE 3
To-be-paid accounts obtained after merging
the to-be-paid accounts in Table 2

| No. | Payer | Payee | Amount |
|---|---|---|---|
| 1 | A | B₁ | 370,000 |
| 2 | A | B₂ | 282,000 |
| 3 | A | B₃ | 130,000 |
| 4 | B₁ | C₁ | 86,900 |
| 5 | B₁ | C₂ | 26,300 |
| 6 | B₁ | C₃ | 74,000 |
| 7 | B₁ | C₄ | 25,000 |
| 8 | B₂ | C₅ | 38,500 |
| 9 | B₂ | C₆ | 35,600 |
| 10 | B₃ | C₇ | 50,400 |
| 11 | B₃ | C₈ | 75,800 |
| 12 | C₁ | D₁ | 26,400 |
| 13 | C₁ | D₂ | 39,800 |
| 14 | C₁ | D₃ | 45,000 |
| 15 | C₂ | D₄ | 25,200 |
| 16 | C₂ | D₅ | 34,900 |
| 17 | C₃ | D₆ | 30,200 |
| 18 | C₃ | D₇ | 12,400 |
| 19 | C₃ | D₈ | 31,400 |
| 20 | C₄ | D₉ | 33,200 |
| 21 | C₄ | D₁₀ | 16,700 |
| 22 | C₅ | D₁₁ | 21,400 |
| 23 | C₅ | D₁₂ | 17,100 |
| 24 | C₆ | D₁₃ | 19,500 |
| 25 | C₆ | D₁₄ | 39,800 |
| 26 | C₆ | D₁₅ | 12,600 |
| 27 | C₇ | D₁₆ | 33,100 |
| 28 | C₇ | D₁₇ | 17,300 |
| 29 | C₈ | D₁₈ | 34,500 |
| 30 | C₈ | D₁₉ | 10,100 |
| 31 | C₈ | D₂₀ | 37,500 |

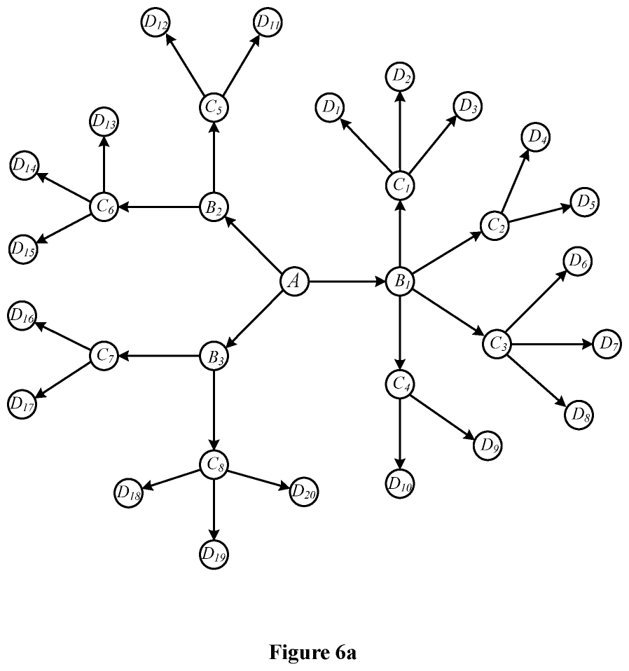

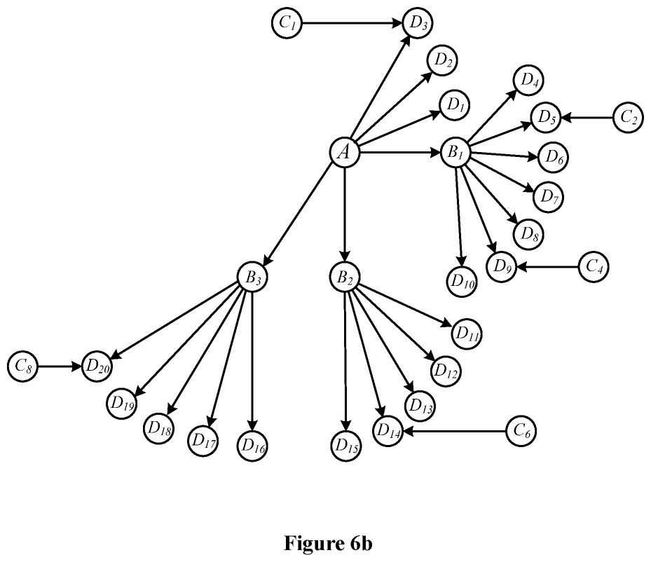

A schematic diagram of an initial dynamic payment network is drawn for the to-be-paid accounts in Table 2, as shown in FIG. 6a.

The path shortening and pruning optimization according to the embodiment of the present disclosure is performed on the initial dynamic payment network shown in FIG. 6a. A splitting list of the to-be-paid accounts is obtained, as shown in the following Table 4.

TABLE 4
To-be-paid Accounts obtained after performing the path shortening
and pruning on the to-be-paid accounts in Table 2

| No. | Payer | Payee | Amount |
|---|---|---|---|
| 1 | A | B₁ | 157,800 |
| 2 | A | D₁ | 26,400 |
| 3 | A | D₂ | 39,800 |
| 4 | A | D₃ | 20,700 |
| 5 | C₁ | D₃ | 24,300 |
| 6 | B₁ | D₄ | 25,200 |
| 7 | B₁ | D₅ | 1,100 |
| 8 | C₂ | D₅ | 33,800 |
| 9 | B₁ | D₆ | 30,200 |
| 10 | B₁ | D₇ | 12,400 |
| 11 | B₁ | D₈ | 31,400 |
| 12 | B₁ | D₉ | 8,300 |
| 13 | B₁ | D₁₀ | 16,700 |
| 14 | C₄ | D₉ | 24,900 |
| 15 | A | B₂ | 207,900 |
| 16 | B₂ | D₁₁ | 21,400 |
| 17 | B₂ | D₁₂ | 17,100 |
| 18 | B₂ | D₁₃ | 19,500 |
| 19 | B₂ | D₁₅ | 12,600 |
| 20 | B₂ | D₁₄ | 3,500 |
| 21 | C₆ | D₁₄ | 36,300 |
| 22 | B₃ | D₁₆ | 33,100 |
| 23 | B₃ | D₁₇ | 17,300 |
| 24 | B₃ | D₁₈ | 34,500 |
| 25 | B₃ | D₁₉ | 10,100 |
| 26 | B₃ | D₂₀ | 31,200 |
| 27 | C₈ | D₂₀ | 6,300 |
| 28 | A | D₃ | 3,800 |

By the path shortening and pruning, a new aggregated payment network is obtained, as shown in FIG. 6b.

Based on Table 4 and FIG. 6b, settlement may be performed on the new payment network after the dynamic network aggregation and balance. For a node having sufficient payment capacity, the settlement may be completed based on the flow and quantity of funds in Table 4 and FIG. 6b. For a node having no sufficient payment capacity, the lacked fund may be recorded as an unpaid account to serve as an initial fund flow link for a next aggregated payment network. The fund virtual payment path in Table 2 and the actual payment path in Table 4 are recorded, and a settlement voucher is generated for the virtual payment path in Table 2, and the settlement voucher is distributed to the node as a fund payment voucher.

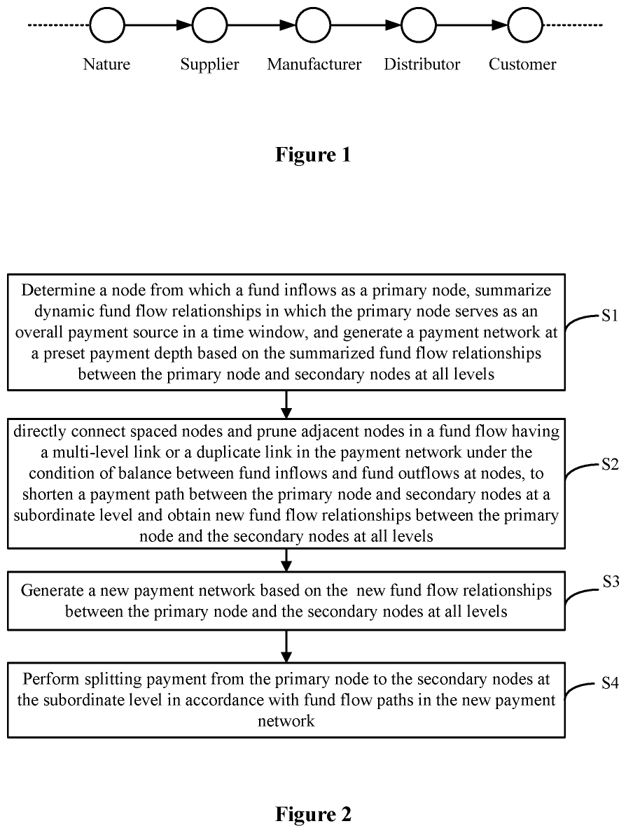

A quantitative analysis for the technical effects of the embodiments of the present disclosure is given in the following. It is assumed that the time required for each transfer is 24 hours, and the fee is 5%. In a case that the payment is performed by using the conventional chain fund flow payment method shown in FIG. 1, that is, in a case that settlement on a node at a next level is performed only after a current node receives settlement accounts from nodes at a previous level, for the screened to-be-paid accounts in Table 2, the total amount of accounts to be transferred is 2,003,600 Yuan, and the fee is 8663 Yuan. In a case that the payment is performed by using the in-depth aggregation payment method provided in the present disclosure, for the to-be-paid accounts in Table 4, the total amount of accounts to be transferred is 907,600 Yuan, and the fee is 4,538 Yuan, which is decreased by 47.6%. Further, since an unnecessary fund inflow and outflow of an intermediate node is reduced, the upstream node of a payment chain directly pays a terminal node of the payment chain, so that the fund arrival time of the terminal node is greatly shortened, which is apparent from the comparison between FIG. 6b and FIG. 6a.

In the embodiments of the present disclosure, for the sake of simplicity, to-be-paid fund flow aggregation based on a time window is adopted. In practical applications, the fund flows in the aggregating process may be classified according to the importance of the clients, that is, the payment and settlement is preferentially performed on important clients, or an expired to-be-paid account is preferentially paid to avoid adverse effects on client credit due to overdue. The above modifications to the present disclosure should be considered as an improvement of the present disclosure and fall within the protection scope of the present disclosure. The payment relationship between the sub-graphs or the nodes of the payment network are not limited to the star relationship illustrated in the embodiments of the present disclosure, and may be in a cross form or a loop form, which does not affect the real-time process and effect of the present disclosure.

An in-depth payment splitting system for dynamic network balance is provided in the present disclosure. The in-depth payment splitting system includes an initial payment network generating module, a path shortening and pruning module, a new payment network generating module and a splitting payment module.

The initial payment network generating module is configured to: determine a node from which a fund inflows as a primary node, summarize dynamic fund flow relationships in which the primary node serves as an overall payment source in a time window, and generate a payment network at a preset payment depth based on the summarized fund flow relationships between the primary node and secondary nodes at all levels.

The path shortening and pruning module is configured to directly connect spaced nodes and prune adjacent nodes in a fund flow having a multi-level link or a duplicate link in the payment network under the condition of balance between fund inflows and fund outflows at nodes, to shorten payment paths between the primary node and secondary nodes at a subordinate level and obtain new fund flow relationships between the primary node and the secondary nodes at all levels.

The new payment network generating module is configured to generate a new payment network based on the new fund flow relationships between the primary node and the secondary nodes at all levels.

The splitting payment module is configured to perform splitting payment from the primary node to the secondary nodes at the subordinate level in accordance with fund flow paths in the new payment network.

In an embodiment of the present disclosure, the in-depth payment splitting system further includes a settlement voucher distributing module. The settlement voucher distributing module is configured to: record a virtual payment path and an actual payment path of a fund, and generate a settlement voucher for the virtual payment path according to an actual payment situation at each node and distribute the settlement voucher as a fund payment voucher of the node to the node, where the virtual payment path is a payment path in an initial payment network, the actual payment path is a payment path in the new payment network, and the settlement voucher includes at least a paid account of the node to nodes connected to the node.

Embodiments of the in-depth payment splitting system for dynamic network balance may refer to the description of the in-depth payment splitting method for dynamic network balance in the foregoing embodiments. The content of the method embodiment is applicable to the system, which is not described herein.

Preferred embodiments of the present disclosure are described above, but are not intended to limit the claims. Those skilled in the art may make various changes and modifications on the embodiments without departing from the spirit and scope of the present disclosure. Therefore, the protection scope of the present disclosure should be defined by the claims of the present disclosure.

1. An in-depth payment splitting method for dynamic network balance, the in-depth payment splitting method comprising:
S1: determining a node from which a fund inflows as a primary node, summarizing dynamic fund flow relationships in which the primary node serves as an overall payment source in a time window, and generating a payment network at a preset payment depth based on the summarized fund flow relationships between the primary node and secondary nodes at all levels;
S2: directly connecting spaced nodes and pruning adjacent nodes in a fund flow having a multi-level link or a duplicate link in the payment network under the condition of balance between fund inflows and fund outflows at nodes, to shorten payment paths between the primary node and secondary nodes at a subordinate level and obtain new fund flow relationships between the primary node and the secondary nodes at all levels;
S3: generating a new payment network based on the new fund flow relationships between the primary node and the secondary nodes at all levels; and
S4: performing splitting payment from the primary node to the secondary nodes at the subordinate level in accordance with fund flow paths in the new payment network.

2. The in-depth payment splitting method for dynamic network balance according to claim 1, wherein step S1 comprises:
S11: defining a primary node, wherein a node from which a fund inflows is determined as the primary node;
S12: determining connection objects having a payment relationship with the primary node in a time window as secondary nodes at a first level, and determining a fund flow amount from the primary node to each of the secondary nodes at the first level to determine a payment sub-graph of the primary node;
S13: determining connection objects having a payment relationship with secondary nodes at an i-th level in the time window as secondary nodes at an (i+1)-th level, and determining a fund flow amount from each of the secondary nodes at the i-th level to each of the secondary nodes at the (i+1)-th level connected with the secondary node at the i-th level, and if there is a payment relationship between the secondary nodes at the i-th level, determining a fund flow amount from one of the secondary nodes at the i-th level to another secondary node at the i-th level connected with the secondary node at the i-th level, to determine payment sub-graphs of all of the secondary nodes at the i-th level, wherein i is an integer ranging from one to (P-1), and P indicates the preset payment depth, wherein the payment sub-graphs are determined progressively beginning from the secondary nodes at the first level; and
S14: generating a payment network having a payment depth of P in the time window based on the payment sub-graphs.

3. The in-depth payment splitting method for dynamic network balance according to claim 2, wherein the fund flow amount is a sum of funds paid between two adjacent nodes in the time window.

4. The in-depth payment splitting method for dynamic network balance according to claim 1, wherein step S2 comprises:
newly generating, for one, some or all of secondary nodes at the first level in the payment network based on fund flow links between the primary node and the secondary nodes at the first level and fund flow links between each of the secondary nodes at the first level and one, some or all of adjacent secondary nodes connected to the secondary node at the first level, fund flow links between the primary node and the adjacent secondary nodes under the condition of balance between fund inflows and fund outflows, and pruning superfluous fund flow links.

5. The in-depth payment splitting method for dynamic network balance according to claim 4, wherein step S2 comprises:
S21: selecting one of the secondary nodes at the first level in the payment network;
S22: selecting an adjacent secondary node connected to the secondary node at the first level, and determining, based on a fund flow link between the primary node and the secondary node at the first level and a fund flow link between the secondary node at the first level and the adjacent secondary node, a fund flow amount difference between the fund flow links, wherein the adjacent secondary node is a secondary node at the first level or a secondary node at a second level;
S23: generating a fund flow link between the primary node and the adjacent secondary node and pruning the fund flow link between the secondary node at the first level and the adjacent secondary node, in a case that the fund flow amount difference is greater than zero; generating a fund flow link between the primary node and the adjacent secondary node and pruning the fund flow link between the secondary node at the first level and the adjacent secondary node and the fund flow link between the primary node and the secondary node at the first level, in a case that the fund flow amount difference is equal to zero; and generating a fund flow link between the primary node and the adjacent secondary node and pruning the fund flow link between the primary node and the secondary node at the first level, in a case that the fund flow amount difference is less than zero, wherein the balance between fund inflows and fund outflows at the primary node, the secondary node at the first level and the adjacent secondary node is not disrupted by the adjusted fund flow links;
S24: selecting another adjacent secondary node connected to the secondary node at the first level, and repeating steps S22 to S23 until all or specified adjacent secondary nodes connected to the secondary node at the first level are adjusted; and
S25: selecting another of the secondary nodes at the first level in the payment network, and repeating steps S22 to S24 until all or specified secondary nodes at the first level are adjusted.

6. The in-depth payment splitting method for dynamic network balance according to claim 1, wherein step S2 further comprises: after the secondary nodes at the first level are adjusted,
newly generating, for one, some or all of secondary nodes at a second level in the payment network based on fund flow links between the secondary nodes at the first level and the secondary nodes at the second level and fund flow links between each of the secondary nodes at the second level and one, some or all of adjacent secondary nodes connected to the secondary node at the second level, new fund flow links between the secondary nodes at the first level and the corresponding adjacent secondary nodes under the condition of balance between fund inflows and fund outflows, and pruning superfluous fund flow links, until fund flow links between the primary node and secondary nodes at a last level are adjusted.

7. The in-depth payment splitting method for dynamic network balance according to claim 1, wherein step S4 comprises:
S41: dividing nodes in the new payment network into net inflow nodes and net outflow nodes according to fund inflows and fund outflows of the nodes, wherein an inflow fund amount of each of the net inflow nodes is larger than an outflow fund amount of the net inflow node, and an inflow fund amount of each of the net outflow nodes is smaller than an outflow fund amount of the net outflow node; and
S42: performing, for each net inflow node, splitting payment in accordance with corresponding fund flow links in the new payment network; and sending a fund complementing request for each net outflow node, and if a net outflow fund of the net outflow node is complemented, performing splitting payment in accordance with corresponding fund flow links in the new payment network, or if the net outflow fund is not complemented, recording a lacked fund as an unpaid account to serve as an initial fund flow link for a next payment network and performing splitting payment on remaining funds in accordance with the fund flow links in the new payment network.

8. The in-depth payment splitting method for dynamic network balance according to claim 1, further comprising:
S5: recording a virtual payment path and an actual payment path of a fund, and generating a settlement voucher for the virtual payment path according to an actual payment situation at each node and distributing the settlement voucher as a fund payment voucher of the node to the node, wherein the virtual payment path is a payment path in an initial payment network, the actual payment path is a payment path in the new payment network, and the settlement voucher comprises at least a paid account of the node to nodes connected to the node.

9. The in-depth payment splitting method for dynamic network balance according to claim 8, wherein step S5 further comprises:
recording each unpaid account as an initial fund flow link for a next payment network.

10. An in-depth payment splitting system for dynamic network balance, the in-depth payment splitting system comprising:
an initial payment network generating module configured to: determine a node from which a fund inflows as a primary node, summarize dynamic fund flow relationships in which the primary node serves as an overall payment source in a time window, and generate a payment network at a preset payment depth based on the summarized fund flow relationships between the primary node and secondary nodes at all levels;
a path shortening and pruning module configured to directly connect spaced nodes and prune adjacent nodes in a fund flow having a multi-level link or a duplicate link in the payment network under the condition of balance between fund inflows and fund outflows at nodes, to shorten payment paths between the primary node and secondary nodes at a subordinate level and obtain new fund flow relationships between the primary node and the secondary nodes at all levels;
a new payment network generating module configured to generate a new payment network based on the new fund flow relationships between the primary node and the secondary nodes at all levels; and
a splitting payment module configured to perform splitting payment from the primary node to the secondary nodes at the subordinate level in accordance with fund flow paths in the new payment network.

11. The in-depth payment splitting system for dynamic network balance according to claim 10, the in-depth payment splitting system further comprising:
a settlement voucher distributing module configured to: record a virtual payment path and an actual payment path of a fund, and generate a settlement voucher for the virtual payment path according to an actual payment situation at each node and distribute the settlement voucher as a fund payment voucher of the node to the node, wherein the virtual payment path is a payment path in an initial payment network, the actual payment path is a payment path in the new payment network, and the settlement voucher comprises at least a paid account of the node to nodes connected to the node.

12. The in-depth payment splitting method for dynamic network balance according to claim 4, wherein step S2 further comprises: after the secondary nodes at the first level are adjusted,
newly generating, for one, some or all of secondary nodes at a second level in the payment network based on fund flow links between the secondary nodes at the first level and the secondary nodes at the second level and fund flow links between each of the secondary nodes at the second level and one, some or all of adjacent secondary nodes connected to the secondary node at the second level, new fund flow links between the secondary nodes at the first level and the corresponding adjacent secondary nodes under the condition of balance between fund inflows and fund outflows, and pruning superfluous fund flow links, until fund flow links between the primary node and secondary nodes at a last level are adjusted.

13. The in-depth payment splitting method for dynamic network balance according to claim 5, wherein step S2 further comprises: after the secondary nodes at the first level are adjusted,
newly generating, for one, some or all of secondary nodes at a second level in the payment network based on fund flow links between the secondary nodes at the first level and the secondary nodes at the second level and fund flow links between each of the secondary nodes at the second level and one, some or all of adjacent secondary nodes connected to the secondary node at the second level, new fund flow links between the secondary nodes at the first level and the corresponding adjacent secondary nodes under the condition of balance between fund inflows and fund outflows, and pruning superfluous fund flow links, until fund flow links between the primary node and secondary nodes at a last level are adjusted.

14. The in-depth payment splitting method for dynamic network balance according to claim 7, further comprising:
S5: recording a virtual payment path and an actual payment path of a fund, and generating a settlement voucher for the virtual payment path according to an actual payment situation at each node and distributing the settlement voucher as a fund payment voucher of the node to the node, wherein the virtual payment path is a payment path in an initial payment network, the actual payment path is a payment path in the new payment network, and the settlement voucher comprises at least a paid account of the node to nodes connected to the node.

15. The in-depth payment splitting method for dynamic network balance according to claim 14, wherein step S5 further comprises:
recording each unpaid account as an initial fund flow link for a next payment network.
